(19) United States
(12) Patent Application Publication
(10) Pub. No.: US 2017/0160545 A1
(43) Pub. Date: Jun. 8, 2017

(54) Head-Up Display Device

(71) Applicant: Yazaki Corporation, Tokyo (JP)

(72) Inventors: Tetsuya Sugiyama, Susono-shi (JP); Takuma Ogisu, Susono-shi (JP)

(73) Assignee: Yazaki Corporation, Tokyo (JP)

(21) Appl. No.: 15/440,380

(22) Filed: Feb. 23, 2017

Related U.S. Application Data
(63) Continuation of application No. PCT/JP2015/077185, filed on Sep. 25, 2015.

(30) Foreign Application Priority Data
Sep. 26, 2014 (JP) 2014-196374
Sep. 26, 2014 (JP) 2014-196375

(51) Int. Cl. G02B 27/01; B60K 35/00

(52) U.S. Cl. CPC G02B 27/0101; B60K 35/00; B60K 2350/2052; B60K 2350/2056; B60K 2350/203; B60K 2350/352; G02B 2207/117; G02B 2027/0127; G02B 27/0093

(57) ABSTRACT

A head-up display device displays information to a driver in a form of a virtual image by projecting display light onto a reflection member. The head-up display device includes a display device which displays a virtual image of a first display image in a first display plane by emitting display light including the first display image and which displays virtual images of a plurality of second display images in a plurality of second display planes by emitting display light beams including the plurality of second display images, respectively. The first display plane is substantially perpendicular to a reference plane. The second display planes are substantially perpendicular to the reference plane and are arranged in a front-rear direction of the driver in a layered manner, and in which the virtual images of the plurality of second display images are displayed so as to be arranged along the reference plane.

### CROSS REFERENCE TO RELATED APPLICATION(S)

This application is a continuation of PCT application No. PCT/JP2015/077185, which was filed on Sep. 25, 2015 based on Japanese Patent Application No. 2014-196374 filed on Sep. 26, 2014 and Japanese Patent Application No. 2014-196375 filed on Sep. 26, 2014, the contents of which are incorporated herein by reference.

### BACKGROUND OF THE INVENTION

1. Field of the Invention

The present invention relates to a head-up display device.

2. Description of the Related Art

Conventionally, head-up display devices (hereinafter referred to as “HUD devices”) have been proposed as vehicular display devices. Capable of displaying information in such a manner it is superimposed on an outside scene, such HUD devices do not force drivers to move their line of sight much and can enhance the legibility of information during driving of vehicles. Such HUD devices include a display unit for emitting display light according to a prescribed display image, and the display light emitted from the display unit is projected onto a reflection member (windshield or combiner). Thus, the driver visually recognizes, as a virtual image, a display image that is displayed by the display unit ahead of the reflection member.

JP-A-2011-73466 discloses a head-up display device that allows operation information of an inter-vehicle distance control device to be recognized easily. This head-up display device displays a forward vehicle mark or an inter-vehicle distance mark in a first display plane when no forward vehicle is detected by the inter-vehicle distance control device. When a forward vehicle is detected by the inter-vehicle distance control device, the head-up display device displays a forward vehicle mark in a second display plane and displays a plurality of marks indicating an inter-vehicle distance in a third display plane. The third display plane is a substantially horizontal plane. On the other hand, the first display plane and the second display plane are planes that are substantially perpendicular to the third plane. And the second plane is spaced forward from the first plane by a prescribed interval.

### SUMMARY OF THE INVENTION

However, in the HUD device disclosed in JP-A-2011-73466, a plurality of marks that are displayed in the third display plane are displayed in the same plane. Furthermore, since marks that are displayed in the third plane so as to be adjacent to each other in the front-rear direction have a small gap, they provide only a small difference between their visual distances. As a result, a problem arises that the plurality of marks are not easily recognized as a 3D image and hence it is difficult to obtain a stereoscopic display effect.

Still further, the HUD device disclosed in JP-A-2011-73466 still has room for improvement in having the driver to recognize a distance to a display plane that serves for display of such a mark as a forward vehicle mark and is substantially perpendicular to the vehicle front-rear direction.

The present invention has been made in view of the above circumstances, and an object thereof is therefore to provide a head-up display device capable of providing a stereoscopic display effect. Another object is to provide a head-up display device capable of giving a driver a better feeling of distance.

The head-up display device according to aspects of the present invention includes the following configurations.

(1) A head-up display device which displays information to a driver in a form of a virtual image by projecting display light onto a reflection member, the head-up display device including:

a display device which displays a virtual image of a first display image in a first display plane by emitting display light including the first display image and which displays virtual images of a plurality of second display images in a plurality of second display planes by emitting display light beams including the plurality of second display images, respectively,

wherein the first display plane is substantially perpendicular to a reference plane, and

wherein the second display planes are substantially perpendicular to the reference plane and are arranged in a front-rear direction of the driver in a layered manner, and in which the virtual images of the plurality of second display images are displayed so as to be arranged along the reference plane.

(2) The head-up display device according to item (1), further including:

a plurality of optical path length adjusting units which are disposed in an optical path between the display device and an eye point of the driver and which adjust optical path lengths of the display light beams emitted from the display device,

wherein the plurality of optical path length adjusting units provide different optical path lengths to the display light beams corresponding to the first display image and the plurality of second display images according to distances to the first display plane and the second layer display planes, respectively.

(3) The head-up display device according to item (1) or (2),

wherein the display device includes a plurality of display portions which emit the display light beams corresponding to the first display image and the plurality of second display images, and

wherein the plurality of display portions are disposed at positions offsetting from each other so as to make the corresponding optical path lengths different from each other according to distances to the first display plane and the second layer display planes, respectively.

(4) The head-up display device according to any one of items (1) to (3),

wherein the plurality of second display images are drawn such that their left and right outlines extend along respective perspective lines which are set according to a prescribed vanishing point.

(5) The head-up display device according to any one of items (1) to (4),

wherein the plurality of second display images are drawn in such a manner as to decrease in image density as the position goes toward the driver.

(6) A head-up display device which displays information to a driver by projecting display light onto a reflection member, the head-up display device including:

an eye point detection unit which detects an eye point of the driver;

a first illumination unit which projects first illumination light for causing the driver to visually recognize a planar display which is substantially perpendicular to a vehicle front-rear direction;

a second illumination unit which projects second illumination light for causing the driver to visually recognize a depth display which includes a component in the vehicle front-rear direction; and

a projection control unit which controls the second illumination light of the second illumination unit such that part of the depth display overlaps with the planar display and such that the depth display is moved in a same direction as a movement direction of the eye point of the driver detected by the eye point detection unit.

(7) The head-up display device according to item (6), further including:

a selection unit which allows selection between emphasis display in which the depth display overlaps with the planar display and ordinary display in which the depth display is displayed adjacent to the planar display,

wherein the projection control unit adjusts a projection direction of the second illumination unit such that part of the depth display overlaps with the planar display if the emphasis display is selected by the selection unit, and adjusts the projection direction of the second illumination unit such that the depth display is displayed adjacent to the planar display if the ordinary display is selected by the selection unit.

In the aspects of the invention, three second display images are displayed along the reference plane so as to be substantially perpendicular to the reference plane and to be arranged in the front-rear direction in a layered manner, whereby a stereoscopic display effect can be obtained. Furthermore, in this display form, the visual distance differences between the second display images are large. Thus, adjoining ones of the second display images have a large gap in the front-rear direction, whereby a stereoscopic display effect can be obtained more properly.

Furthermore, the aspects of the invention can provide a head-up display device capable of giving a driver a better feeling of distance.

### BRIEF DESCRIPTION OF THE DRAWINGS

FIG. 1 is a schematic diagram showing a vehicle to which an HUD device according to a first embodiment is applied.

FIG. 2 is a block diagram showing the configuration of a display unit.

FIGS. 3A and 3B are explanatory diagrams for description of a function relating to four optical path length adjusting units.

FIG. 4 is an explanatory diagram illustrating visual distance differences between layers.

FIG. 5 is an explanatory diagram illustrating visual distance differences between layers in a conventional display form.

FIGS. 6A and 6B are explanatory diagrams illustrating modified versions of images to be recognized by a driver.

FIG. 7 is a block diagram showing the configuration of a modified illumination device.

FIG. 8 is a schematic diagram showing what exist in a vehicle compartment to which an HUD system according to a second embodiment is applied.

FIG. 9 is a block diagram showing the configuration of the HUD system.

FIG. 10 shows a detailed configuration of an illumination unit shown in FIGS. 8 and 9.

FIG. 11 is a configuration diagram showing a state that a second display is rotated on a rotary shaft shown in FIG. 10

FIG. 12 is a schematic front view showing a display state shown in FIG. 10.

FIGS. 13A and 13B are schematic diagrams showing the display state shown in FIG. 10; FIG. 13A shows a case that the eye point is moved rightward a little, and FIG. 13B shows a case that the eye point is moved leftward a little.

FIG. 14 is a schematic front view showing a display state shown in FIG. 11.

FIGS. 15A and 15B are schematic diagrams showing the display state shown in FIG. 11; FIG. 15A shows a case that the eye point is moved rightward a little, and FIG. 15B shows a case that the eye point is moved leftward a little.

FIG. 16 is a flowchart illustrating a control method of a HUD device according to the second embodiment.

### DETAILED DESCRIPTION OF THE EXEMPLARY EMBODIMENTS

### Embodiment 1

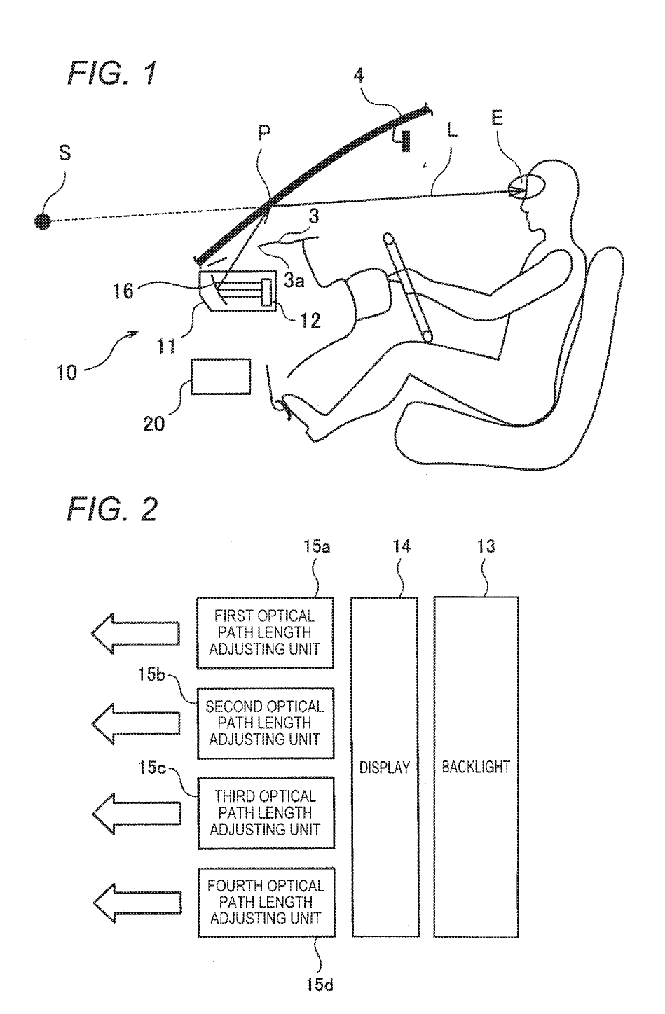

FIG. 1 is a schematic diagram showing what exist in a vehicle compartment to which an HUD device (head-up display device) according to this embodiment is applied. In the vehicle compartment, a steering wheel is disposed in front of a driver and an instrument panel 3 is disposed in front of the steering wheel. A windshield 4 which is the boundary between the spaces inside and outside the vehicle and enables see-through viewing of a scene ahead of the vehicle is disposed in front of the instrument panel 3.

The instrument panel 3 is a member that partitions a front space of the vehicle compartment and is molded in a prescribed shape. The instrument panel 3 is formed with, at a prescribed position, an opening 3a which connects the spaces inside and outside the instrument panel 3, and a prescribed region P of the windshield 4 is disposed above the opening 3a.

The HUD device 10 for displaying information, as a virtual image S, by far-point display, in such a manner that it is superimposed on a scene ahead of the vehicle being viewed by the driver is installed in the vehicle. The HUD device 10 includes an illumination device 11 and a controller 20, and forms the virtual image S utilizing the windshield 4 which is a reflection member.

The illumination device 11 is housed in a housing case and disposed inside the instrument panel 3. The illumination device 11 includes a display unit 12 and an aspheric mirror 16.

The display unit 12 emits display light L that corresponds to a display image to be displayed to the driver. The display unit 12 will be described later in detail.

The aspheric mirror 16 is a member for reflecting the display light L emitted from the display unit 12 toward the windshield 4. The aspheric mirror 16 is supported in such a manner that its inclination can be adjusted by drive force of a motor (not shown). This inclination adjustment makes it possible to adjust the projection position of the display light L on the windshield 4.

The illumination device 11 projects the display light L emitted from the display unit 12 onto the prescribed region P of the windshield 4 via the aspheric mirror 16. The projected display light L is reflected by the windshield 4 and reaches an eye point E of the driver. As a result, the driver visually recognizes a virtual image S of the display image corresponding to the display light L as if it were located outside the windshield 4.

The controller 20 is a device for controlling the illumination device 11, and can be a microcomputer that mainly includes a CPU, a ROM, a RAM, and an input/output interface.

FIG. 2 is a block diagram showing a detailed configuration of the display unit 12. The display unit 12 includes a display device including a backlight 13 and a display 14 and first to fourth optical path length adjusting units 15a to 15d.

The backlight 13 is an LED(s), for example. Light emitted from the backlight 13 shines on the display 14 via a prescribed optical system.

The display 14, which is an LCD, for example, forms a display image. The display 14 emits display light L (see FIG. 1) corresponding to the display image by allowing part of the light emitted from the backlight 13 and coming from the back side to pass through itself. The display light L thus formed go toward the first to fourth optical path length adjusting units 15a to 15d. The display image that is formed by the display 14 is an image of display information (including numerals, characters, marks, etc.) to be displayed to the driver and passengers and is controlled by the controller 20 on the basis of a display image signal that is input from a host controller.

The display 14 has only one display area, which can be divided into a plurality of areas. In the embodiment, the one display area can be divided into four regions, that is, first to fourth display regions. Among the four regions, the first display region serves to form a first display image. And prescribed information (e.g., presence/absence of a forward vehicle) can be displayed in the form of the first display image. Each of the second to fourth display regions serves to form a second display image, and prescribed information (e.g., inter-vehicle distance) can be displayed by combining the three second display images. The four display regions and the four optical path length adjusting units 15 are in one-to-one correspondence, and display light L emitted from each display region shines on the corresponding optical path length adjusting unit 15.

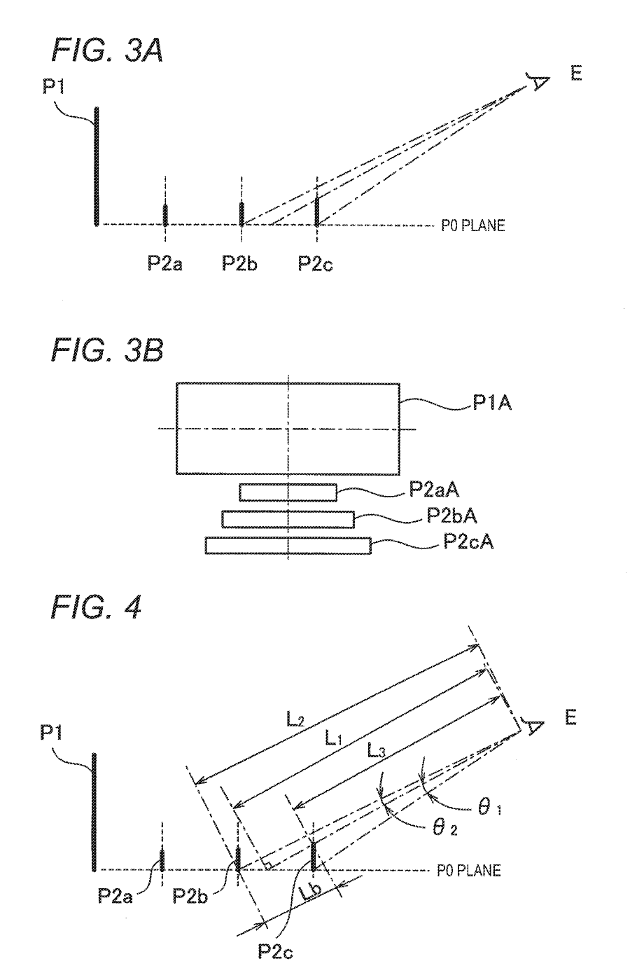

The first to fourth optical path length adjusting units 15a to 15d are disposed on an optical path between the display 14 and the eye point E, each of them is a means for adjusting the optical path length of display light L emitted from the display 14. Each of the first to fourth optical path length adjusting units 15a to 15d includes a plurality of folding mirrors, for example, and adjusts the optical path length for display light L by guiding it using the folding mirrors. FIG. 3 is an explanatory diagram for description of a function relating to the first to fourth optical path length adjusting units 15a to 15d.

The first optical path length adjusting unit 15a adjusts the optical path for display light L emitted from the first display region of the display 14. The first optical path length adjusting unit 15a displays a virtual image of a first display image P1A corresponding to display light L emitted from the display 14 (first display region) in a first display plane P1 which is set substantially perpendicularly to a prescribed reference plane P0 (e.g., horizontal plane).

The second optical path length adjusting unit 15b adjusts the optical path for display light L emitted from the second display region of the display 14. The second optical path length adjusting unit 15b displays a virtual image of a second display image P2aA corresponding to display light L emitted from the display 14 (second display region) in a first layer display plane P2a which is closer to the vehicle in the vehicle front-rear direction than the first display plane P1 is.

The third optical path length adjusting unit 15c adjusts the optical path for display light L emitted from the third display region of the display 14. The third optical path length adjusting unit 15c displays a virtual image of a second display image P2bA corresponding to display light L emitted from the display 14 (third display region) in a second layer display plane P2b which is closer to the vehicle than the first layer display plane P2a is.

The fourth optical path length adjusting unit 15d adjusts the optical path for display light L emitted from the fourth display region of the display 14. The fourth optical path length adjusting unit 15d displays a virtual image of a second display image P2cA corresponding to display light L emitted from the display 14 (fourth display region) in a third layer display plane P2c which is closer to the vehicle than the second layer display plane P2b is.

The three, that is, first to third, layer display planes P2a to P2c are set substantially perpendicularly to the reference plane P0, and the virtual images of the three second display images P2aA to P2cA are displayed along the reference plane P0.

Thus, the display light L that has passed the first optical path length adjusting unit 15a among the first to fourth optical path length adjusting units 15a to 15d takes a longest optical path, and the corresponding virtual image is displayed in the first display plane P1 which is located at the deepest position. The display light beams that have passed the second optical path length adjusting unit 15b, the third optical path length adjusting unit 15c, and the fourth optical path length adjusting unit 15d, respectively, take optical paths that shorten in this order. The corresponding virtual images are displayed along the reference plane P0 at the positions that are closer to the vehicle than the first display plane P1 is so as to face the driver substantially squarely.

FIG. 4 is an explanatory diagram illustrating a visual distance difference Lb in the display form of the embodiment. The visual distance difference Lb can be calculated according to the following equation:

Lb=L₂ cos θ₂−L₃. [Formula 1]

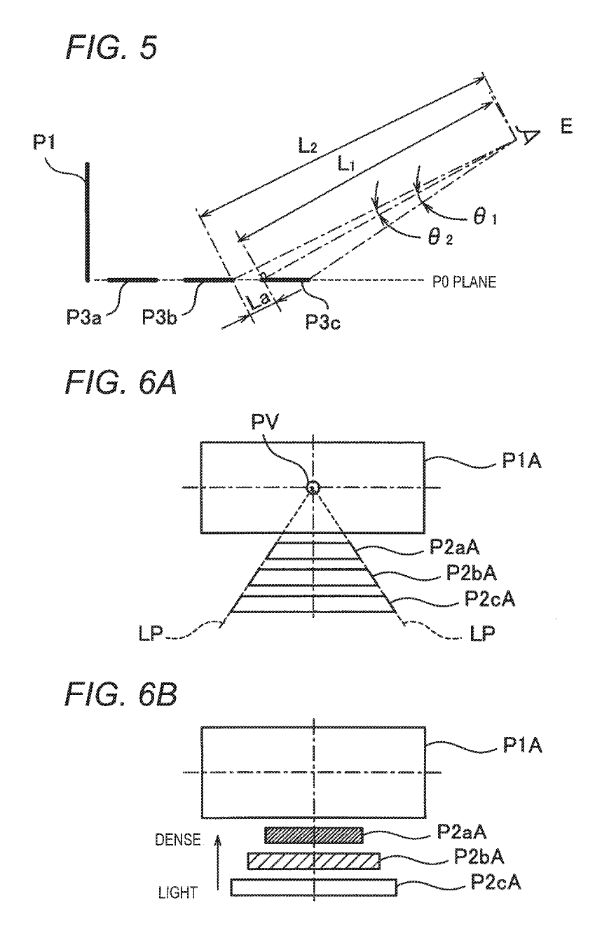

FIG. 5 is an explanatory diagram illustrating a visual distance difference La in a case that virtual images of the three second display images are displayed in planar display planes P3a to P3c that are arranged along the reference plane P0. The visual distance difference La can be calculated according to the following equation:

La=L₂ cos θ₂−L₁. [Formula 2]

Comparison between Formulae 1 and 2 show that the visual distance difference Lb is larger than the visual distance difference La. Thus, according to the display form of the embodiment, the second display images P2aA to P2cA can be recognized so as to have large gaps in the front-rear direction.

As described above, in the embodiment, the HUD device 10 includes the backlight 13 and the display 14 which display a virtual image of a first display image P1A in the first display plane P1 which is substantially perpendicular to the reference plane P0 and display virtual images of three second display images P2aA to P2cA along the reference plane P0 by emitting respective display light beams L corresponding to the first display image P1A and the three second display images P2aA to P2cA. In the HUD device 10, the virtual images of the three second display images P2aA to P2cA are displayed in the three second layer display planes P2a to P2c which are substantially perpendicular to the reference plane P0 and are arranged in the front-rear direction in a layered manner.

In particular, the HUD device 10 further includes the four first to fourth optical path length adjusting units 15a to 15d for adjusting the optical path lengths of display light beams L emitted from the display 14. The first to fourth optical path length adjusting units 15a to 15d give different optical path lengths to the display light beams L corresponding to the first display image P1A and the three second display images P2aA to P2cA according to the distances to the first display plane P1 and the three second layer display planes P2a to P2c, respectively.

With the above configuration, three second display images P2aA to P2cA are displayed along the reference plane P0 so as to be substantially perpendicular to the reference plane P0 and to be arranged in the front-rear direction in a layered manner, whereby a stereoscopic display effect can be obtained. Furthermore, in this display form, the visual distance differences between the second display images are large. Thus, adjoining ones of the second display images P2aA to P2cA have a large gap in the front-rear direction, whereby a stereoscopic display effect can be obtained more effectively.

To obtain a stereoscopic display effect, second display images P2aA to P2cA may be drawn in the following forms. In a first method, as shown in FIG. 6A, three second display images P2aA to P2cA are drawn in such a manner that their left and right outlines extend along respective perspective lines Lp that are set according to a prescribed vanishing point PV. With this method, the three second display images P2aA to P2cA are enhanced in the sense of perspective in the front-rear direction, whereby a better stereoscopic display effect can be obtained.

In a second method, as shown in FIG. 6B, three second display images P2aA to P2cA are drawn in such a manner as to decrease in image density as the position goes toward the vehicle. That is, three second display images P2aA to P2cA are drawn in a denser color as the position goes away from the vehicle (i.e., in a lighter color as the position goes toward the vehicle). With this method, the sense of perspective is enhanced in the front-rear direction, whereby a better stereoscopic display effect can be obtained.

In the above embodiment, the display area of the one display unit (backlight 13 and the display 14) is divided into the four regions and display light beams L corresponding to respective display images P1A and P2aA to P2cA are emitted. However, another configuration is possible in which display light beams L corresponding to display images P1A and P2aA to P2cA are emitted using four display portions, respectively.

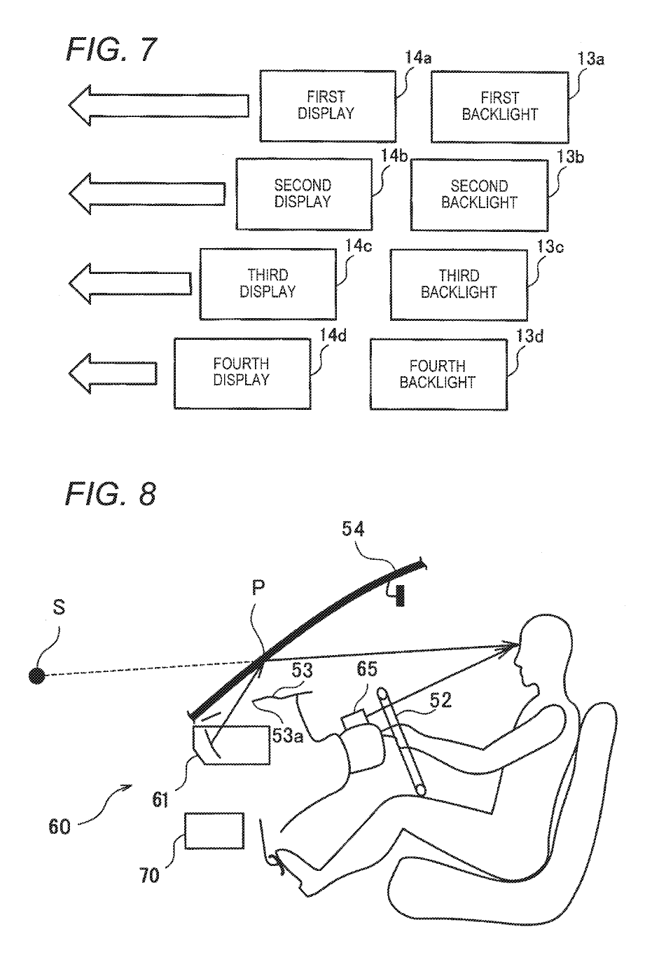

In the above embodiment, the first to fourth optical path length adjusting units 15a to 15d are provided as the means for producing different optical path lengths because display light beams L corresponding to respective display images P1A and P2aA to P2cA have the same illumination position. However, as shown in FIG. 7, another configuration is possible in which a display unit includes four display portions (four backlights 13a to 13d and four displays 14a to 14d) and display light beams L corresponding to respective display images P1A and P2aA to P2cA are emitted individually. In this case, different optical path lengths are obtained by disposing the four display portions at positions that offset from each other.

Although in the above embodiment three second display images P2aA to P2cA are formed, the invention is not limited to this case; it suffices that a plurality of second display images be formed. Although the four optical path length adjusting units are provided, a proper number of optical path length adjusting units may be provided according to the number of second display images P2aA to P2cA.

Although the invention has been described in detail by referring to the particular embodiment, it is apparent to those skilled in the art that various changes and modifications are possible without departing from the spirit and scope of the invention.

Although in the above embodiment display light emitted from the illumination unit is projected onto the windshield, another configuration is possible in which display light is projected onto a reflection member other than the windshield. Example of such a reflection member are a combiner and a half mirror that is disposed so as to face a meter instrument having meters and serves for display of a virtual image.

### Embodiment 2

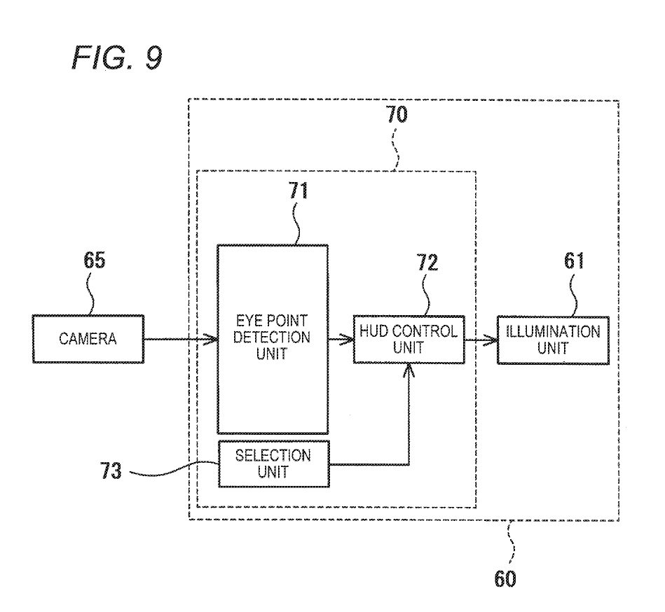

FIG. 8 is a schematic diagram showing what exist in a vehicle compartment to which an HUD system (head-up display system) according to this embodiment is applied. FIG. 9 is a block diagram showing the configuration of the HUD system. In the vehicle compartment, a steering wheel 52 is disposed in front of a driver and an instrument panel 53 is disposed in front of the steering wheel 52. A windshield 54 which is the boundary between the spaces inside and outside the vehicle and enables see-through viewing of a scene ahead of the vehicle is disposed in front of the instrument panel 53.

The instrument panel 53 is a member that partitions a front space of the vehicle compartment and is molded in a prescribed shape. The instrument panel 53 is formed with, at a prescribed position, an opening 53a which connects the spaces inside and outside the instrument panel 3, and the windshield 54 is disposed above the opening 53a.

The HUD system for displaying information to the driver as a virtual image by far-point display is installed in the vehicle. The HUD system mainly includes a HUD device 60 and a camera 65.

The HUD device 60 is a device for displaying information in such a manner that it is superimposed on a scene etc. ahead of the vehicle being viewed by the driver. The HUD device 60 includes an illumination unit 61 and a controller 70, and forms a virtual image utilizing the windshield 54 which is a reflection member.

The illumination device 61 is housed in a housing case and disposed inside the instrument panel 53. The illumination unit 61 serves to project illumination light onto the windshield 54.

The controller 70 is a device for controlling the illumination unit 61, and can be a microcomputer that mainly includes a CPU, a ROM, a RAM, and an input/output interface. From a functional point of view, the controller 70 has an eye point detection unit 71, a HUD control unit (projection control unit) 72, and a selection unit 73.

The eye point detection unit 71 serves to detect the eye point of the driver on the basis of an image supplied from the camera 65 which shoots a prescribed region, including his or her face, of the driver. The HUD control unit 72 serves to control the illumination unit 61. For example, the driver of the vehicle may be tall or short. If a tall driver sits in the driver seat, his or her eye point is located at a high position and a projection position P needs to be changed accordingly. Likewise, if the driver is short, his or her eye point is located at a low position. Thus, it is necessary to change the projection position P, too. The HUD control unit 72 controls the illumination unit 61 so as to produce proper display by changing the projection position P in the above described manner on the basis of a detection result of the eye point detection unit 71. Furthermore, the HUD control unit 72 not only controls the projection position P but also controls what are to be displayed by first and second displays 61a and 61b (described later) on the basis of the detection result of the eye point detection unit 71 and other information.

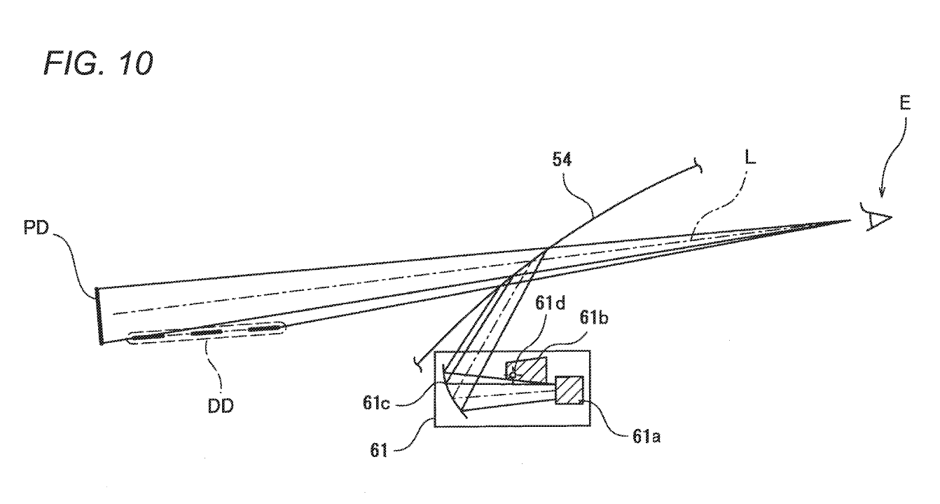

FIG. 10 shows a detailed configuration of the illumination unit 61 shown in FIGS. 8 and 9. For convenience of description, the windshield 54, the eye point E, etc. are also shown in FIG. 10. As shown in FIG. 10, the illumination unit 61 includes a first display (first illumination unit) 61a, a second display (second illumination unit) 61b, and a reflection plate 61c.

Each of the first display 61a and the second display 61b serves to project illumination light corresponding to display information to be presented to the driver. Each of the first display 61a and the second display 61b includes an LCD (liquid crystal display) for displaying display information such as numerals, characters, etc. and a backlight such as an LED(s) for causing the LCD to emit light.

The reflection plate 61c is a member for reflecting, toward the windshield 54, illumination light beams projected by the first display 61a and the second display 61b. The reflection plate 61c is supported in such a manner that its inclination can be adjusted, and its inclination can be adjusted by drive force of a motor (not shown). By virtue of this inclination adjustment, the projection position P can be controlled according to the height of the eye point E of the driver in the above-described manner.

Furthermore, in the embodiment, because of its position and orientation, the first display 61a functions as a device for projecting first illumination light for causing the driver to visually recognize a planar display PD that is substantially perpendicular to the vehicle front-rear direction (the line of sight L of the driver). And, because of its position and orientation, the second display 61b functions as a device for projecting second illumination light for causing the driver to visually recognize a depth display DD including a component in the vehicle front-rear direction.

The above-mentioned term “depth display DD including a component in the vehicle front-rear direction” means a display in which at least the component in the depth direction (vehicle front-rear direction) is longer than the component in the vehicle top-bottom direction.

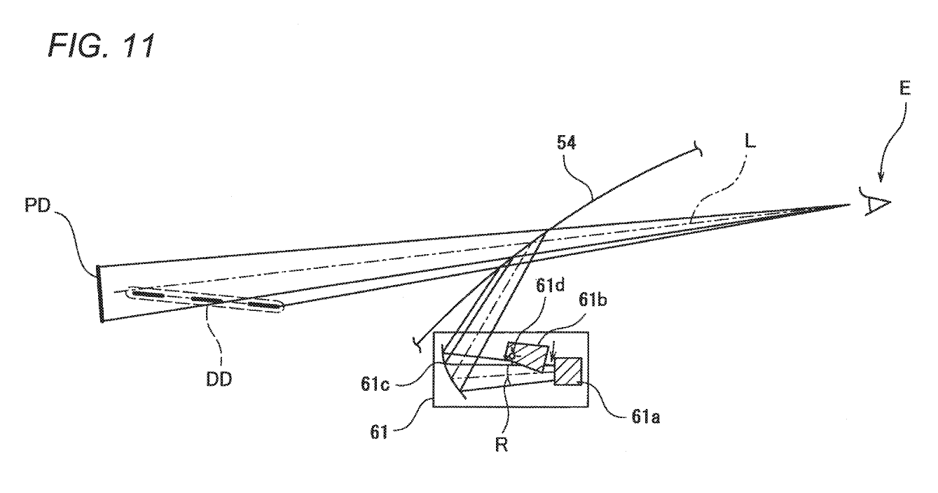

Furthermore, the second display 61b includes a rotary shaft 61d capable of adjusting the light projection direction. FIG. 11 is a configuration diagram showing a state that the second display 61b is rotated on the rotary shaft 61d shown in FIG. 10.

As shown in FIG. 11, the second display 61b is rotatable clockwise (as viewed in the figure) on the rotary shaft 61d. When the second display 61b is rotated, the second display 61b overlaps with a projection region R of the first display 61a.

As a result, part of a depth display DD of the second display 61b overlaps with a planar display PD of the first display 61a. In the following description, the display state shown in FIG. 10 will be referred to as an ordinary display and the display state shown in FIG. 11 will be referred to as an emphasis display.

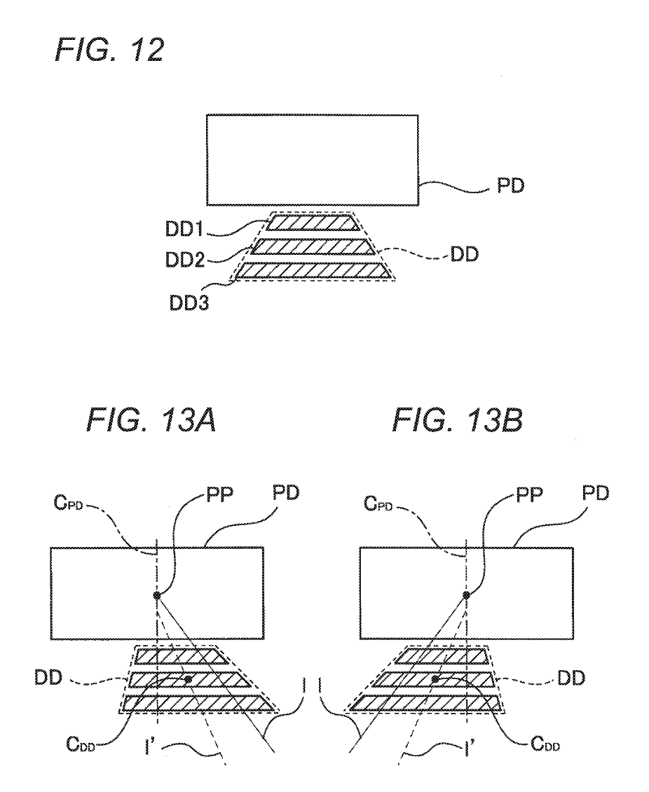

FIG. 12 is a schematic front view showing the display state shown in FIG. 10. FIG. 13 is a schematic diagram showing the display state shown in FIG. 10; FIG. 13A shows a case that the eye point E is moved rightward a little, and FIG. 13B shows a case that the eye point E is moved leftward a little.

As shown in FIG. 12, in the display state shown in FIG. 10, the depth display DD is displayed below the planar display PD. The depth display DD which is displayed adjacent to the planar display PD allows the driver to easily recognize a distance to the planar display PD.

In the embodiment, the depth display DD includes a plurality of band-shaped images DD1 to DD3 which are arranged in the direction of the line of sight L of the driver (depth direction) and each of the plurality of band-shaped images DD1 to DD3 is trapezoidal. As for the lateral widths of the plurality of band-shaped images DD1 to DD3, the deepest, first band-shaped image DD1 is smallest and the third band-shaped image DD3 which is closest to the vehicle is greatest. A depth (distance) is expressed by the first to third band-shaped images DD1 to DD3 which are trapezoidal and whose lateral widths decrease as the position goes deeper.

Furthermore, as shown in FIGS. 13A and 13B, when the eye point E is moved rightward or leftward, the second display 61b projects second illumination light that depends on the movement. More specifically, the eye point detection unit 71 detects a movement of the eye point E of the driver on the basis of an image supplied from the camera 65. By controlling the second display 61b, the HUD control unit 72 controls second illumination light so that the depth display DD is moved in the same direction as the movement direction of the eye point E of the driver. The resulting movement distance of the depth display DD depends on the movement distance of the eye point E of the driver.

In this control, as shown in FIGS. 13A and 13B, the HUD control unit 72 controls second illumination light of the second display 61b so that the center CDD of the depth display DD is placed on a projection straight line I′ that is a projection, onto the depth display DD, of a straight line I that connects the eye point E of the driver detected by the eye point detection unit 71 and the planar display PD.

More specifically, a straight line I is determined that connects the eye point E of the driver detected by the eye point detection unit 71 and a particular point PP on the center line CPD and projected onto the depth display DD (in the direction perpendicular to the plane of the depth display DD). The HUD control unit 72 controls the details of second illumination light so that a projected straight line I′ passes the center CDD of the depth display DD.

As a result, as shown in FIGS. 13A and 13B, the depth display DD is moved relative to the planar display PD according to a variation of the eye point E and the driver is given a better stereoscopic feeling by moving his or her eye point E.

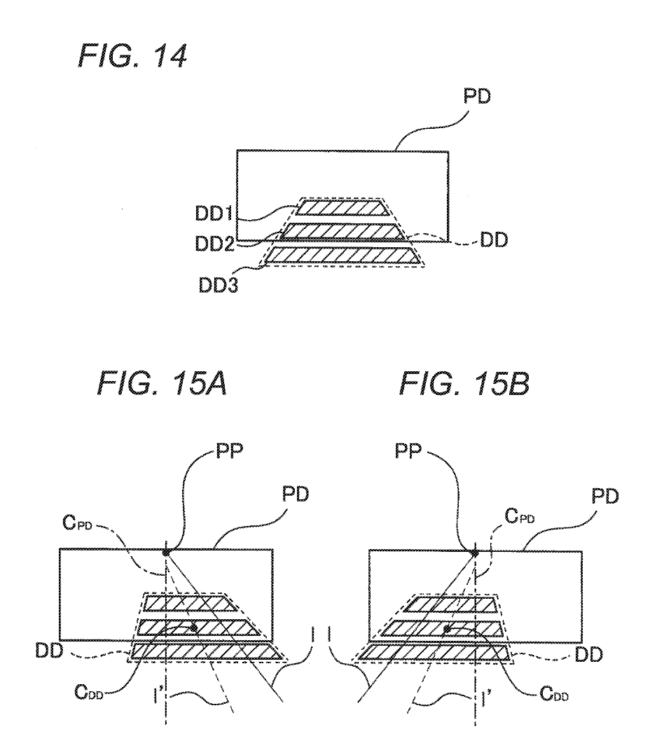

FIG. 14 is a schematic front view showing the display state shown in FIG. 11. FIGS. 15A and 15B are a schematic diagram showing the display state shown in FIG. 11; FIG. 15A shows a case that the eye point E is moved rightward a little, and FIG. 15B shows a case that the eye point E is moved leftward a little.

As shown in FIG. 14, in the display state shown in FIG. 10, the depth display DD overlaps with of the planar display PD (i.e., part of the former is laid on the bottom half of the latter). Where the depth display DD overlaps with the planar display PD in this manner, it is easier to compare the display positions of the planar display PD and the depth display DD than in the case where they are displayed adjacent to each other. The driver can therefore recognize a distance even more easily.

Furthermore, as shown in FIGS. 15A and 15B, the HUD control unit 72 controls the details of second illumination light so that a projected straight line I′(described above) passes the center CDD of the depth display DD. As a result, when an eye point variation has occurred, the depth display DD varies relative to the planar display PD in the state that the display positions of the planar display PD and the depth display DD can be compared with each other easily, whereby the driver is given a stereoscopic feeling even more effectively.

Whether to employ the ordinary display form of FIG. 10 and the emphasis display form of FIG. 11 is determined according to a selection result of the selection unit 73. The selection unit 73 serves to select the ordinary display or the emphasis display according to a vehicle environment, a manipulation made by the driver, or the like. If the emphasis display is selected by the selection unit 73, the HUD control unit 72 adjusts the projection direction of the second display 61b to the state shown in FIG. 11 and thereby causes second illumination light to be projected so that the planar display PD and the depth display DD overlap with each other. If the ordinary display is selected by the selection unit 73, the HUD control unit 72 adjusts the projection direction of the second display 61b to the state shown in FIG. 10 and thereby causes second illumination light to be projected so that the depth display DD is displayed below the planar display PD.

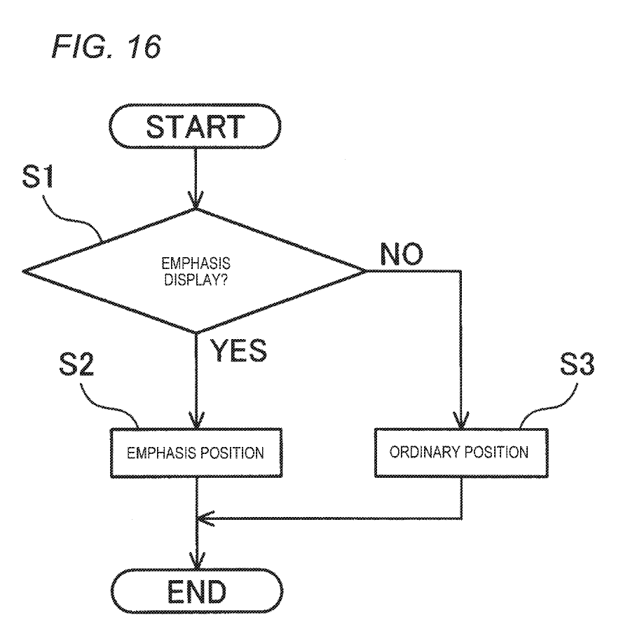

FIG. 16 is a flowchart illustrating a control method of the HUD device 60 according to the second embodiment. As shown in FIG. 16, first, the HUD control unit 72 judges whether or not the emphasis display is selected by the selection unit 73 (S1). If judging that the emphasis display is selected (S1: yes), the HUD control unit 72 moves the second display 61b to the emphasis position shown in FIG. 11 (S2). As a result, the driver of the vehicle visually recognizes the planar display PD and the depth display DD in a state shown in FIGS. 14 and 15. Then the process shown in FIG. 16 is finished.

On the other hand, if judging that the emphasis display is not selected (i.e., the ordinary display is selected) (S1: no), the HUD control unit 72 moves the second display 61b to the ordinary position shown in FIG. 10 (S3). As a result, the driver of the vehicle visually recognizes the planar display PD and the depth display DD in a state shown in FIGS. 12 and 13. Then the process shown in FIG. 16 is finished.

As described above, according to the HUD device 60 of the embodiment, since a depth display DD overlaps with a planar display PD which is substantially perpendicular to the vehicle front-rear direction, the display positions of the planar display PD and the depth display DD can be compared with each other easily. Furthermore, since second illumination light of the second display 61b is controlled so that the depth display DD is moved in the same direction as a movement direction of the eye point E of the driver, if the eye point E of the driver is moved rightward when the planar display PD is viewed from the driver side, the depth display DD is also moved rightward. Likewise, if the eye point E of the driver is moved leftward when the planar display PD is viewed from the driver side, the depth display DD is also moved leftward. In this manner, the depth display DD is moved according to a movement of the eye point E of the driver. In addition, since this movement is made in a state that the display positions of the planar display PD and the depth display DD can be compared with each other easily, that is, the depth display DD overlaps with the planar display PD, the driver can be given a stereoscopic feeling even more effectively by moving his or her eye point E. Thus, the driver can be given a better feeling of distance.

Furthermore, since selection between the emphasis display in which part of the depth display DD overlaps with the planar display PD and the ordinary display in which the depth display DD is displayed adjacent to the planar display PD is possible, switching can be made between the emphasis display and the ordinary display according to a situation, a taste of the driver, or the like, which can increase convenience.

Although the invention has been described in detail by referring to the particular embodiment, it is apparent to those skilled in the art that various changes and modifications are possible without departing from the spirit and scope of the invention.

For example, although in the embodiment the projection direction of second illumination light is changed by changing the orientation of the second display 61b itself, the invention is not limited to this case. Another configuration is possible in which the projection direction of second illumination light is changed by projecting illumination light emitted from the second display 61b onto a screen and changing the orientation of the screen.

In addition, although in the embodiment a depth display DD is produced by the one second display 61b, the invention is not limited to this case; a depth display DD may be produced by a plurality of second displays 61b. Furthermore, a half mirror may be provided which transmits first illumination light and reflects second illumination light like a screen does.

Features of the above-described head-up display devices according to the embodiments of the invention will be described concisely below in the form of items [1] to [7]:

[1] A head-up display device (HUD device 10) which displays information to a driver in a form of a virtual image by projecting display light onto a reflection member (windshield 4), the head-up display device including:

a display device (backlight 13 and display 14) which displays a virtual image of a first display image (P1A) in a first display plane (P1) by emitting display light including the first display image and which displays virtual images of a plurality of second display images (P2aA to P2cA) in a plurality of second display planes (P2a, P2b, P2c) by emitting display light beams including the plurality of second display images, respectively,

wherein the first display plane is substantially perpendicular to a reference plane (P0), and

wherein the second display planes are substantially perpendicular to the reference plane and are arranged in a front-rear direction of the driver in a layered manner, and in which the virtual images of the plurality of second display images are displayed so as to be arranged along the reference plane.

[2] The head-up display device according to item [1], further including:

a plurality of optical path length adjusting units (first to fourth optical path length adjusting units 15a to 15d) which are disposed in an optical path between the display device and an eye point of the driver and which adjust optical path lengths of the display light beams emitted from the display device,

wherein the plurality of optical path length adjusting units provide different optical path lengths to the display light beams corresponding to the first display image and the plurality of second display images according to distances to the first display plane and the second layer display planes, respectively.

[3] The head-up display device according to item [1] or [2],

wherein the display device includes a plurality of display portions (backlights 13a to 13d, displays 14a to 14d) which emit the display light beams corresponding to the first display image and the plurality of second display images, and

wherein the plurality of display portions are disposed at positions offsetting from each other so as to make the corresponding optical path lengths different from each other according to distances to the first display plane and the second layer display planes, respectively.

[4] The head-up display device according to any one of items [1] to [3],

wherein the plurality of second display images are drawn such that their left and right outlines extend along respective perspective lines (Lp) which are set according to a prescribed vanishing point (PV).

[5] The head-up display device according to any one of items [1] to [4],

wherein the plurality of second display images are drawn in such a manner as to decrease in image density as the position goes toward the driver.

[6] A head-up display device which displays information to a driver by projecting display light onto a reflection member (windshield 54), the head-up display device including:

an eye point detection unit (71) which detects an eye point of the driver;

a first illumination unit (first display 61a) which projects first illumination light for causing the driver to visually recognize a planar display which is substantially perpendicular to a vehicle front-rear direction;

a second illumination unit (second display 61b) which projects second illumination light for causing the driver to visually recognize a depth display which includes a component in the vehicle front-rear direction; and

a projection control unit (HUD control unit 72) which controls the second illumination light of the second illumination unit such that part of the depth display overlaps with the planar display and such that the depth display is moved in a same direction as a movement direction of the eye point of the driver detected by the eye point detection unit.

[7] The head-up display device according to item [6], further including:

a selection unit (73) which allows selection between emphasis display in which the depth display overlaps with the planar display and ordinary display in which the depth display is displayed adjacent to the planar display,

wherein the projection control unit adjusts a projection direction of the second illumination unit such that part of the depth display overlaps with the planar display if the emphasis display is selected by the selection unit, and adjusts the projection direction of the second illumination unit such that the depth display is displayed adjacent to the planar display if the ordinary display is selected by the selection unit.

Although the invention has been described in detail by referring to the particular embodiments, it is apparent to those skilled in the art that various changes and modifications are possible without departing from the spirit and scope of the invention.

The embodiments of the invention provide an advantage that a stereoscopic display effect can be obtained more properly. Providing this advantage, the embodiments of the invention are useful when applied to head-up display devices.

1. A head-up display device which displays information to a driver in a form of a virtual image by projecting display light onto a reflection member, said head-up display device comprising:
a display device which displays a virtual image of a first display image in a first display plane by emitting display light comprising the first display image and which displays virtual images of a plurality of second display images in a plurality of second display planes by emitting display light beams comprising the plurality of second display images, respectively,
wherein the first display plane is substantially perpendicular to a reference plane, and
wherein the second display planes are substantially perpendicular to the reference plane and are arranged in a front-rear direction of the driver in a layered manner, and in which the virtual images of the plurality of second display images are displayed so as to be arranged along the reference plane.

2. The head-up display device according to claim 1, further comprising:
a plurality of optical path length adjusting units which are disposed in an optical path between the display device and an eye point of the driver and which adjust optical path lengths of the display light beams emitted from the display device,
wherein the plurality of optical path length adjusting units provide different optical path lengths to the display light beams corresponding to the first display image and the plurality of second display images according to distances to the first display plane and the second layer display planes, respectively.

3. The head-up display device according to claim 1,
wherein the display device comprises a plurality of display portions which emit the display light beams corresponding to the first display image and the plurality of second display images, and
wherein the plurality of display portions are disposed at positions offsetting from each other so as to make the corresponding optical path lengths different from each other according to distances to the first display plane and the second layer display planes, respectively.

4. The head-up display device according to claim 1,
wherein the plurality of second display images are drawn such that their left and right outlines extend along respective perspective lines which are set according to a prescribed vanishing point.

5. The head-up display device according to claim 1,
wherein the plurality of second display images are drawn in such a manner as to decrease in image density as the position goes toward the driver.

6. A head-up display device which displays information to a driver by projecting display light onto a reflection member, said head-up display device comprising:
an eye point detection unit which detects an eye point of the driver;
a first illumination unit which projects first illumination light for causing the driver to visually recognize a planar display which is substantially perpendicular to a vehicle front-rear direction;
a second illumination unit which projects second illumination light for causing the driver to visually recognize a depth display which comprises a component in the vehicle front-rear direction; and
a projection control unit which controls the second illumination light of the second illumination unit such that part of the depth display overlaps with the planar display and such that the depth display is moved in a same direction as a movement direction of the eye point of the driver detected by the eye point detection unit.

7. The head-up display device according to claim 6, further comprising:
a selection unit which allows selection between emphasis display in which the depth display overlaps with the planar display and ordinary display in which the depth display is displayed adjacent to the planar display,
wherein the projection control unit adjusts a projection direction of the second illumination unit such that part of the depth display overlaps with the planar display if the emphasis display is selected by the selection unit, and adjusts the projection direction of the second illumination unit such that the depth display is displayed adjacent to the planar display if the ordinary display is selected by the selection unit.
